(19) United States
(12) Patent Application Publication
(10) Pub. No.: US 2015/0071262 A1
(43) Pub. Date: Mar. 12, 2015

(54) Method and Apparatus for Signaling That Stations are Awake and Ready to Receive Data

(71) Applicant: Nokia Corporation, Espoo (FI)

(72) Inventors: Klaus Doppler, Albany, CA (US); Chittabrata Ghosh, Fremont, CA (US); Sayantan Choudhury, Berkeley, CA (US)

(21) Appl. No.: 14/395,129

(22) PCT Filed: Mar. 28, 2013
(86) PCT No.: PCT/FI2013/050349

§ 371 Date: Oct. 17, 2014

Related U.S. Application Data
(60) Provisional application No. 61/636,118, filed on Apr. 20, 2012.

(51) Int. Cl. H04W 72/12; H04W 72/04

(52) U.S. Cl. CPC H04W 72/12; H04W 72/0446
USPC 370/336

(57) ABSTRACT

A method, apparatus and software configured to compile a traffic indication message indicating downlink traffic is waiting for a plurality of users; and only for each nth ones of the users for which a response to the traffic indication message is received, the response identifying the nth user in a time period corresponding to a portion of the traffic indication message which indicates downlink traffic is waiting for that user, schedule the downlink traffic in each nth slot corresponding to the time period. A method, apparatus and software configured to determine that a received traffic indication message indicates downlink traffic is waiting for a particular user; map a portion of the traffic indication message, that indicates the downlink traffic is waiting for the particular user, to an uplink time period; and send, in the mapped uplink time period, a response indicating that the particular user is awake.

### TECHNICAL FIELD

This invention relates generally to wireless communications, and more specifically is directed toward signaling to an access node or access point that users/stations are awake and ready to receive data.

### BACKGROUND

In order to conserve power in portable devices such as user equipments in cellular network systems and stations in wireless local access network (WLAN) systems, these portable devices switch between an active state and a sleep state. Different radio access technologies have different terms for these active and sleep states, but in general during the active state the portable devices may be sending or receiving data or merely monitoring to see if there is any data scheduled to be sent to them, while during the sleep state the device has the option to go into a low power or idle mode during which its monitoring activity is greatly reduced or eliminated. The sleep state is interrupted at periodic intervals so the portable device can check if there is any data scheduled for it by the access node/access point. Some future adaptations of certain wireless systems have a far larger number of portable devices attached to the same access node than has been the practice in the past, and in some cases the network will not always be aware of which devices are active. At any given scheduling event by the access node this means that at least some of the scheduled portable devices will be in the sleep mode. Merely continuing past signaling regimens which were designed around a much lesser total number of attached portable devices is wasteful of scarce radio spectrum. The teachings below address this issue.

### BRIEF DESCRIPTION OF THE DRAWINGS

FIG. 1 is a timing diagram illustrating signaling for indicating which STAs identified in a TIM are awake, without polling, according to one non-limiting example of these teachings.

FIG. 2 is a schematic overview illustrating one example of a radio environment with one AP and multiple STAs and is an exemplary environment in which these teachings may be practiced to advantage according to one non-limiting example of these teachings.

FIG. 3 is a logic flow diagram that illustrates from the perspective of an access point AP the operation of a method, and a result of execution by an apparatus of a set of computer program instructions embodied on a computer readable memory, in accordance with the exemplary embodiments of this invention.

FIG. 4 is a logic flow diagram that illustrates from the perspective of a station STA the operation of a method, and a result of execution by an apparatus of a set of computer program instructions embodied on a computer readable memory, in accordance with the exemplary embodiments of this invention.

FIG. 5 is a simplified block diagram of two STAs and an AP which are exemplary devices suitable for use in practicing the exemplary embodiments of the invention.

### BRIEF DESCRIPTION

According to an aspect of the present invention, there are provided methods as specified in claims 1 and 7.

According to another aspect of the present invention, there is provided a non-transitory program storage device readable by a machine as specified in claim 8.

According to another aspect of the present invention, there is provided an apparatus as specified in claims 9 and 10.

According to an aspect of the present invention, there are provided methods as specified in claims 11 and 16.

According to another aspect of the present invention, there is provided a non-transitory program storage device readable by a machine as specified in claim 17.

According to yet another aspect of the present invention, there is provided an apparatus as specified in claims 18 and 19.

Embodiments of the invention are defined in the dependent claims.

### DETAILED DESCRIPTION

As a general principle for the WLAN radio access technology, the access point AP polls various stations STAs to inform them that there is downlink traffic for them and to find out if the STA has uplink traffic to send. In the IEEE 802.11 ah version of WLAN under development as well as others, the AP instead sends in its beacon a traffic indication map (TIM) which indicates those particular STAs for which the AP has downlink traffic. IEEE 802.11 ah supports the concept that STAs may be in a sleep state for hours or even days. The result is that some STAs indicated in the TIM as having downlink data may not be awake to receive it, and often the AP will not know when it sends the TIM which STAs are sleeping and which are awake to receive the TIM. Additionally, IEEE 802.11ah supports a much larger number of STAs served by a single AP than other iterations of the WLAN family of standards. The end result is that there may be a large number of polls sent to STAs that are addressed in the TIM but not awake to respond to the poll or receive their downlink data from the AP. This is not the most efficient use of the available bandwidth.

One solution might be to supplement the TIM with a polling procedure as above so that the AP polls the stations to see if they're awake before sending their downlink data. But for a power-saving poll (PS-Poll), it might take the AP 20 to 40 msec to send 14 to 28 PS-Polls. Since the AP can potentially send a new TIM quite frequently this is not seen to be the most optimal solution for efficiently using the radio spectrum for communicating data.

The inventors consider this quite a long time, resulting in an inefficient utilization of the radio resources that could be otherwise used for data transmissions. For example, in the worst case this 20-40 msec protected poll interval recurs every beacon interval of 100 msec. Below is detailed a more efficient use of the radio resources which still supports a network in which STAs indicated in the TIM might be asleep and not receive the TIM at all.

In an exemplary embodiment, special sequences such as Zadoff-Chu sequences are used for the individual STAs to indicate it is awake and ready to receive data. Zadoff-Chu sequences have a known root, and cyclic shifts of those roots are possible to allow for the STA to signal more than simply ‘awake’, as will be detailed below. A position in the TIM is mapped to a transmission slot (or more generally a time period) when the sequence is sent by the STA. Other embodiments may use some something besides the Zadoff-Chu sequences for the STA to indicate it is ready for downlink data, and more generically this signaling by the STA may be considered as an awake indication since it serves to inform the AP that the STA which sent it is awake and ready to receive data.

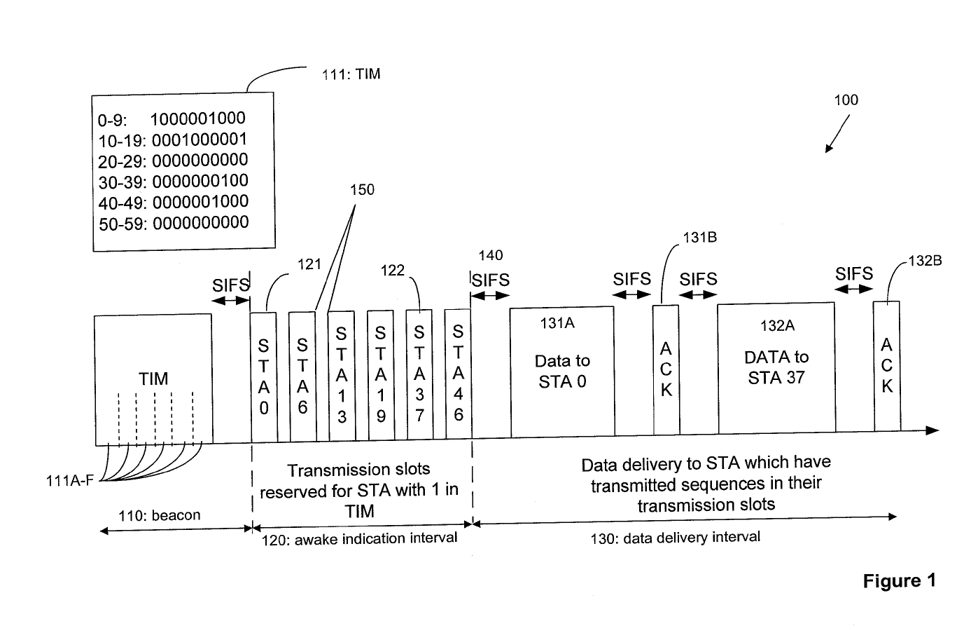

Respecting the sequences themselves, in an example embodiment these sequences themselves does not identify the STAs sending them; the AP knows to which STA any received sequence applies by mapping each bit in the TIM which indicates there is traffic to a slot in the awake indication interval 120 as will be described below with respect to FIG. 1. In this regard every STA may use the same sequence and the AP can still distinguish each of them from one another by the transmission slot mapping to the TIM traffic bit. In another embodiment the AP may assign sequences such that STAs having adjacent traffic signaling bit positions in the TIM have different sequences. This helps account for a lack of exact precision in synchronization within the awake indication interval 120 so the AP can identify which STA responded even if the sending STA transmitted it somewhat outside the bounds of its own transmission slot 121, 122 that maps from its unique TIM traffic indicating bit.

Each STA indicated in the TIM has an allocated transmission slot after receiving the beacon containing a downlink TIM. Sending their assigned sequence in this allocated transmission slot indicates to the AP that this particular STA is awake and ready to receive data. For each of the STAs which send their sequence the AP then sends the data. As is clear from FIG. 1, example embodiments of these teachings can operate with no PS-poll message per STA no explicit poll per STA (which would take about 1.4 msec in 802.11ah with a 2 MHz channel), and neither is there a separate acknowledgement (ACK) message from each STA that is awake corresponding to each PS-poll message. While not shown in the FIG. 1 signaling diagram, the AP may send a group ACK (acknowledgment) for the sequences which were reported in response to the TIM.

Now consider a more detailed but non-limiting example from FIG. 1. Assume there are 60 STAs attached to the AP, indexed for convenience of this description as 0 . . . 59. In the current TIM 111 the AP has downlink data only for STA #0, #6, #13, #19, #37 and #46. When sending the TIM the AP is not aware which, if any, of those six STAs is awake. While there are other ways to send traffic indications to multiple users/STAs, for this specific example assume that the resulting TIM is shown at the upper left corner of FIG. 1, in which the TIM has sixty traffic indicator bits, one for each of the STAs attached to the AP. A bit set to value “1” in the TIM indicates there is downlink traffic for that STA, a bit set to value “0” in the TIM indicates there is none. Specifically, a “1” valued bit indicates the AP has downlink buffered data for the corresponding STA. So the example TIM of FIG. 1 has only six bits set to value “1”, and reading left to right and top to bottom the position of those “1” valued bits corresponds to the index of the respective STA.

The TIM may be considered to have different portions 1111A-F, each portion corresponding to one of the STA-specific bits. The illustrated portions 111A-F correspond to only the “1” valued bits, in order. Though the “0” valued bits are also present, it is the order of the “1” valued bits in the TIM 111 that is relevant to the timeslots 121, 122 that the STAs send their sequence to indicate being awake, regardless of any intervening “0” valued bits in the TIM. In this example the order of the “1” valued bits in portions 111A-F, those STAs for which the TIM indicates the AP has buffered downlink data, is STA #0, #6, #13, #19, #37 and #46.

In the FIG. 1 example the AP may send the TIM 111 in its beacon 210, which is followed by an awake indication interval 120 and then by a data delivery interval 130. Following the TIM 111 there is a short interframe space SIFS 140 or some other interval which, due to a lack of transmission from the AP over that interval 140, allows the STAs to decode the TIM 111. Termination of the SIFS 140 or other interval can coincide with the start of the awake indication interval 120, or the start of that interval 120 may be indicated by an end-of-beacon frame. All STAs listening to the TIM can count there are six “1” valued bits and can see if one of those bits corresponds to itself.

In this example assume STA #0, STA #12, STA #22, STA #37 and STA #51 are awake and each hears the TIM. There is a “0” valued bit set for STAs #12, #22 and #51 so they can go into a sleep mode, or await to signal the AP if they have uplink data to send. None of those STAs are active again in FIG. 1. STA #0 and STA #37 have a corresponding “1” valued bit and so will need to signal the AP in the awake indication interval 120 that they are awake and ready to receive their downlink data.

Since there were six “1” valued bits in the TIM but neither the AP nor any individual STA is aware if any or none or all of them are in a sleep state, there are six transmission slots or opportunities in the awake indication interval 120. The order of these transmission slots is the order of the “1” valued bits in the TIM, as shown in FIG. 1: STA #0, #6, #13, #19, #37 and #46. It is in these slots that the respective STA sends its sequence, if it is awake. In this example STAs #6, #13, #19 and #46 are in a sleep state and so those slots go unused. The TIM 111 also indicates there is traffic for STA #0 and STA #37 which are awake, and so they send their respective sequence (which may be the same sequence) in their respective slots 121 and 122.

For the shortest signaling in the transmissions slots 121, 122 the STAs can send only a sequence as noted above (for example, only the root sequence). But as mentioned above in another exemplary embodiment the STA can indicate additional information in this transmission, such as by using different cyclic shifts applied to the Zadoff-Chu root sequence. As one non-limiting example, a cyclic shift of 5 could indicate that the STA only wants to receive traffic with a quality of service (QoS) class higher than 3.

So in summary, after some pre-arranged time period (SIFS in FIG. 1) following the TIM 111 the first STA with the data bit set (STA #0) sends a known sequence (Zadoff-Chu sequence with known root) to the AP in a slot 121 that maps to that data bit. The second STA with the data bit set (STA #6) is not awake and does not transmit the sequence in its mapped second transmission slot. Similarly also the third transmission slot for STA #13 is not used. The next STA which is awake is the fifth STA (STA #37) and transmits its sequence in the reserved timeslot that maps to its TIM traffic bit. As noted above, in one embodiment the AP may send a group ACK at the end of the awake indication interval 120 that ACKs the two sequences it received. Since the WLAN system operates in license-exempt bandwidth, the AP may also send a network allocation vector NAV to protect the transmission slots in the awake indication interval 120 from interference by other radio transmitters.

There is a time gap 150 between each of these reserved timeslots within the awake indication interval 120 to mitigate interference between two adjacent sequences transmitted by different STAs, such as may arise due to different propagation delays or small synchronization errors. This gap 150 may be much shorter than a SIFS 140 because each STA that will be sending its sequence knows in advance the maximum number of sequences that may be sent; one for each “1” valued bit in the TIM 111, and the time allotted for sending each sequence as well as the time allotted for each gap 150 between them may be fixed in an embodiment. As such the gap 150 need only serve as a guard period.

After the time reserved for STAs to transmit their sequences in the awake indication interval 120, the AP will start to transmit data to the STAs which have indicated by their sequence that they are ready to receive their data. In this example since only two STAs responded in the awake indication interval 120 with their sequence, there are only two data blocks sent in the data delivery interval 130. The AP will send only data blocks corresponding to the sequences it received in the awake indication interval 120. In an example embodiment, based on the number of “1” valued bits set in the TIM 211 the STAs each know the amount of transmission slots in the awake indication interval 120 and so they know when the data delivery interval 130 will start. In another or the same example embodiment, which is shown in FIG. 1 for its simplicity, the order of the downlink data blocks 131A, 132A follows the order that the STAs responded in the awake indication interval 120 with their sequences, so in this embodiment there is a mapping also from the used transmission slots 121, 122 of the awake indication interval 120 to the downlink data slots 131A, 132A of the data delivery interval 130. In one example embodiment alternative to the preceding one there is no such mapping of time slots from the awake indication interval 120 to the data delivery interval 130 and instead the AP sends a separate data scheduling or allocation message which informs the responding STAs when their data 131A, 132A will be sent in the data delivery interval 130.

Assume the above embodiment in which the order of these data blocks follows the order of those STAs which sent their sequences in the awake indication interval 120. Since each STA also listened to all slots in that interval 120, each knows in what order its own data will be sent by the AP in the data delivery interval 130 since there is a one to one mapping. So in FIG. 1 the first data block 131A is for STA #0 and the next and final data block 132A is for STA #37. Each STA sends an ACK 131B, 132B for the data block it receives, with a SIFS 140 between each distinct transmission in the data delivery interval 130 in the FIG. 1 embodiment.

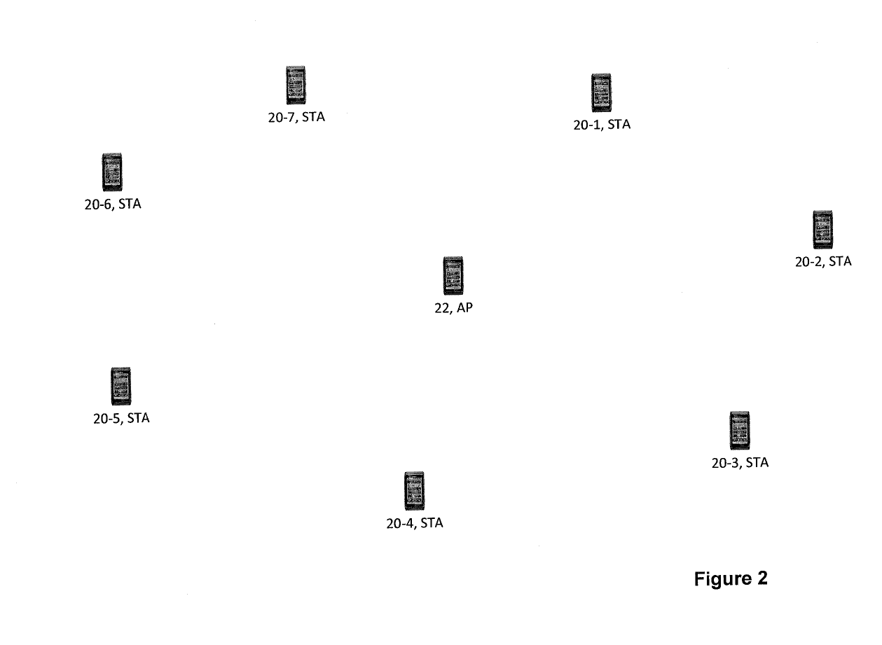

FIG. 2 illustrates a SIFS 140 between the end of the last transmission slot (or group ACK, not shown) of the awake indication interval 120 and the first data block 131A that the AP sends in the data delivery interval 130. Since the timing of the start of the data delivery interval 130 may be known in one of the example embodiments from how many “1” value bits are in the TIM 111, in some embodiments this gap might be as short as a guard period, similar to that between the transmission slots for the STAs' sequences. In practice the exact start time for the data delivery block 130 may not be known so precisely. If a given embodiment utilizes a group ACK at the close of the awake indication interval 120, the exact start time of the data delivery interval 130 may not be known until after listening for all the transmission slots since a group ACK that acknowledges only one sequence may be shorter than a group ACK that acknowledges six of them. Thus in a non-limiting embodiment the group ACK also has an indication of the start time for the first data block in the data delivery interval 130. The group ACK may indicate this as the start of the first data block 131A itself, or the start of the data delivery interval 130 from which the STAs know to offset by a SIFS 140, or some other time instant that is commonly understood by the AP and the STAs. In another non-limiting embodiment that uses a scheduling allocation to tell the responding STAs where their data block will be, the start time may instead be indicated in that scheduling allocation.

Now consider a quantitative comparison. Sending a power saving (PS) poll in a 2 MHz channel configuration uses about 20 OFDM symbols (orthogonal frequency multiple access). If we also assume that each PS-poll is followed by a short ACK, this will take an additional 15 OFDM symbols. Assuming a symbol duration of 36 μsec and also a SIFS period of 160 μsec for each PS-poll/ACK combination, this polling procedure will take 1.4 msec.

Compare that to the FIG. 1 embodiment of these teachings. If we assume for this quantitative review that sending a single sequence takes 40 μsec and each guard period spans an additional 4 μsec, meaning that 31 sequences can be sent in the same time it takes for the above polling procedure. This is seen to be a substantial efficiency gain over utilizing a PS-polling procedure to learn which STAs addressed in a given TIM are awake.

For a fuller appreciation of these teachings FIG. 2 illustrates an example radio environment consistent with what is envisioned for IEEE 802.11 ah: a single AP 22 is serving a large number of STAs 20 (shown as 20-1 through 20-7, but one STA is generically referred to below as 20) via wireless links. In one deployment contemplated for IEEE 802.11ah and each STA 20 is associated with an electrical power transmission or distribution point for reporting sensing information to the AP 22 to enable a ‘smart-grid’. By example, one AP 22 may serve meter-based STAs in a large apartment complex. The AP 22 may also performing its own sensing on an electrical transmission/distribution point with which it is associated, which in WLAN terminology makes it an AP-STA. In other relevant radio environments the AP 22 need not also be operating as a STA. Each of the other APs 20 are non-AP STAs.

In WLAN there are contention based and contention free access periods, referring to whether transmitting STAs contend for the wireless medium and are subject to collision with other STA's transmission (contention-based) or whether the STA will be transmitting on a protected radio slot in which other STAs will not be transmitting (contention-free). FIG. 1 assumes the TIM and intervals 120, 130 are contention-free but they may also be protected in a contention-based implementation by being pre-assigned by the AP.

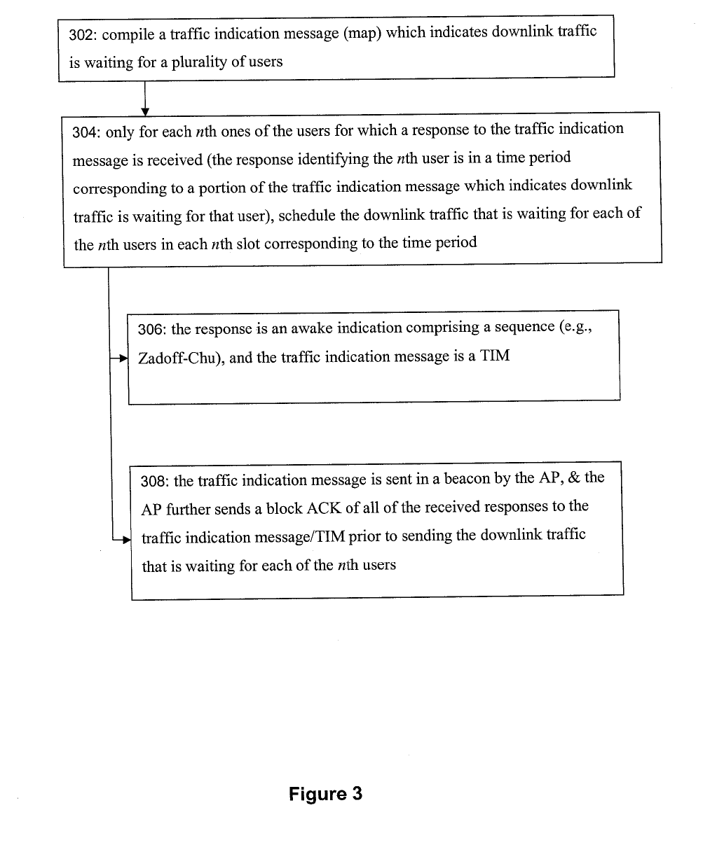

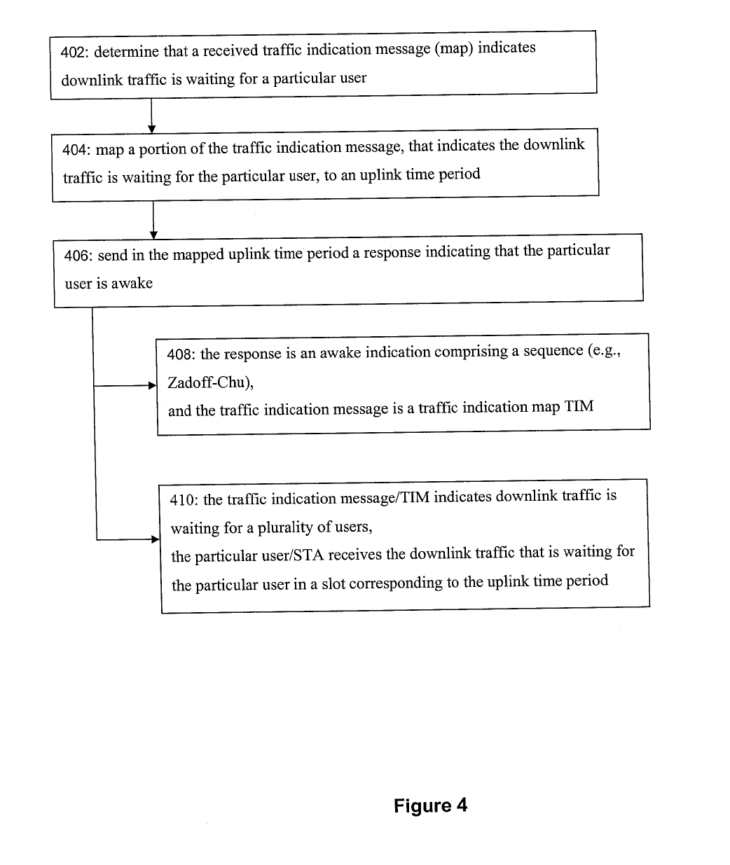

The logic flow diagrams of FIGS. 3-4 summarize some of the non-limiting and exemplary embodiments of the invention from the perspective of the AP 22 or certain components thereof if not performed by the entire AP (FIG. 3), and from the perspective of the STA 20 or certain components thereof if not performed by the entire STA (FIG. 4). These Figures may each be considered to illustrate the operation of a method, and a result of execution of a computer program stored in a computer readable memory, and a specific manner in which components of an electronic device are configured to cause that electronic device to operate, whether such an electronic device is the access node in full or one or more components thereof such as a modem, chipset, or the like.

The various blocks shown at FIGS. 3-4 may also be considered as a plurality of coupled logic circuit elements constructed to carry out the associated function(s), or specific result of strings of computer program code or instructions stored in a memory. Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

First consider FIG. 3 which is from the perspective of the AP. Each of the STAs are distinguished from one another as an nth STA (or nth users or user equipments UEs). At block 302 of FIG. 3 the AP 22 (or one or more components thereof) compiles a traffic indication message which indicates downlink traffic is waiting for a plurality of users. At block 304, only for each nth ones of the users for which a response to the traffic indication message is received, in which the response identifying the nth user is in a time period (timeslot) corresponding to a portion of the traffic indication message which indicates downlink traffic is waiting for that user, the AP 22 schedules the downlink traffic that is waiting for each of the nth users in each nth slot corresponding to the time period.

Further portions of FIG. 3 reflect further non-limiting details from the example embodiments above. Block 306 specifies for the above examples that the response is an awake indication comprising a sequence such as a Zadoff Chu sequence, and the traffic indication message is a traffic indication map TIM.

Block 308 tells that the traffic indication message is sent in a beacon by the AP 22 which further sends a block ACK of all of the received responses to the traffic indication message/TIM prior to sending the downlink traffic that is waiting for each of the nth users. In this case, one of the examples above detailed that the responses to the traffic indication message are received in an awake indication interval and the block ACK further indicates when is the start of a data delivery interval in which the scheduled downlink traffic will be sent.

More particularly, the responses to the traffic indication message are received in an awake indication interval which is synchronized for a response from each user for which the traffic indication message indicates downlink traffic is waiting, in order of the users indicated in the traffic indication message. And also scheduling the downlink traffic is in a data delivery interval following the awake indication interval. In one embodiment above each nth slot for data in the data delivery interval is consecutive in order of the nth user's response in the awake indication interval, in another embodiment the AP sends an allocation for scheduling the downlink traffic for only those responding users.

Now consider FIG. 4 which is from the perspective of one of the STAs 20. At block 402 of FIG. 4 the STA 20 determines that a received traffic indication message indicates downlink traffic is waiting for it (e.g., traffic is waiting for a particular user/STA). Then at block 404 the STA maps a portion of the traffic indication message that indicates the downlink traffic is waiting for the particular user to an uplink time period (timeslot), and at block 406 sends in the mapped uplink time period a response indicating that the particular user is awake.

Further portions of FIG. 4 reflect further non-limiting details from the example embodiments above. Block 408 tells that the response is an awake indication comprising a sequence such as a Zadoff Chu sequence, and the traffic indication message is a traffic indication map TIM.

Block 410 describes one example embodiment in that, for the case in which the traffic indication message/TIM indicates downlink traffic is waiting for a plurality of users, then the particular user/STA receives the downlink traffic that is waiting for the particular user in a slot corresponding to the uplink time period. A different example embodiment utilizes a separate allocation from the AP for scheduling the traffic rather than mapping timeslots between the awake indication interval and the data delivery interval.

In the FIG. 1 example the user equipment receives the traffic indication message in a beacon from an access point/AP, and further receives from the AP prior to receiving the downlink traffic a block ACK of N responses indicating that each nth one of N user equipments is awake (N is an integer). For example, the N responses and the block ACK are in an awake indication interval and the block ACK further indicates the start of delivery of the downlink traffic.

Stated more concisely but specific for a WLAN system, each of the AP and the STA map a position of a downlink traffic indicator bit in a TIM to an uplink transmission slot, in which the position is associated with a particular STA. From the AP's perspective, then it determines that the STA is ready to receive downlink traffic if a sequence is received in the uplink transmission slot. From the STA's perspective, then it indicates that the STA is ready to receive downlink traffic by sending a sequence in the uplink transmission slot.

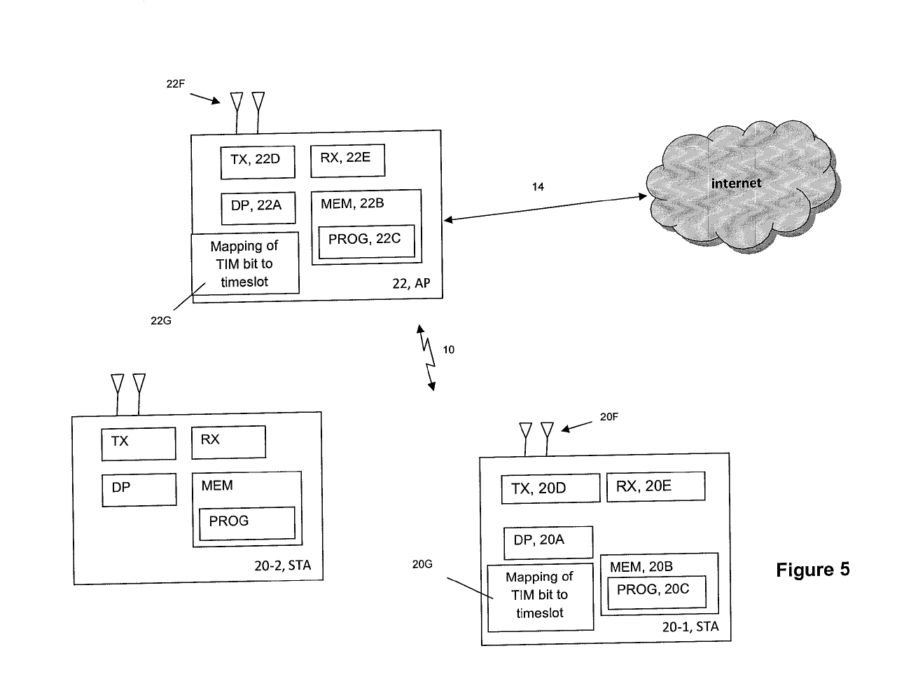

Reference is now made to FIG. 5 for illustrating a simplified block diagram of various electronic devices and apparatus that are suitable for use in practicing the exemplary embodiments of this invention. In FIG. 5 an AP 22 is adapted for communication over a wireless medium/link 10 with an apparatus, such as a mobile device/terminal or a radio-equipped sensor or a user equipment, all of which stand in the place of the AP 20 in the examples above. FIG. 5 shows only two STAs 20-1 and 20-2 but as noted above with respect to FIGS. 2 and 3 there may many STAs served by a single AP 22. The AP 22 may be any access node (including frequency selective repeaters) of any wireless network such as WLAN in the examples above, or it may be an access node (Node B, e-Node B, base station, etc) that utilizes some other radio access technology such as for example cellular technologies LTE, LTE-A, GSM, GERAN, WCDMA, and the like which may manage downlink traffic with a map/TIM, or which may be adapted for device-to-device and/or machine-to-machine communications. The various STAs may also form a cognitive radio network, with one of the cognitive radios or a node of a formal network taking on the functions detailed above for the AP. The AP 22 provides the STAs 20-1, 20-2 with connectivity to further networks via data link 14 (for example, a data communications network/Internet as shown and/or a publicly switched telephone network).

One STA 20-1 is detailed below (referred to as STA 20) but the other STA 20-2 is functionally similar though it may be not be identical or even made by the same manufacturer. The STA 20 includes processing means such as at least one data processor (DP) 20A, and storing means such as at least one computer-readable memory (MEM) 20B storing at least one computer program (PROG) 20C or other set of executable instructions. In some embodiments the STA 20 may also include communicating means such as a transmitter TX 20D and a receiver RX 20E that may be embodied for example in a chipset or RF front end chip. In other embodiments the STA 20 may comprise one or more antennas 20F. In either case the TX 20D, RX 20E and antennas 20F are for bidirectional wireless communications with the AP 22. Also stored in the MEM 20B at reference number 20G is the UE's algorithm or function or selection logic for mapping among the TIM traffic indicator bit and the transmission slot in the awake indication interval and the STA's identifying sequence as detailed above in various non-limiting examples.

The AP 22 may comprise processing means such as at least one data processor (DP) 22A, storing means such as at least one computer-readable memory (MEM) 22B storing at least one computer program (PROG) 22C or other set of executable instructions. The AP 22 may also comprise communicating means such as a transmitter TX 22D and a receiver RX 22E for bidirectional wireless communications with the STA 20, for example via one or more antennas 22F. The AP 22 may store at block 22G the algorithm or function or selection logic for mapping among the TIM traffic indicator bits and the transmission slots in the awake indication interval and the various STAs' identifying sequences as set for by non-limiting examples above.

At least one of the PROGs 22C/22G in the AP 22, and PROGs 20C/20G in the STA 20, is assumed to include a set of program instructions that, when executed by the associated DP 22A/20A, may enable the device to operate in accordance with the exemplary embodiments of this invention, as detailed above. In these regards the exemplary embodiments of this invention may be implemented at least in part by computer software stored on the MEM 20B, 22B which is executable by the DP 20A of the STA 20 and/or by the DP 22A of the AP 22, or by hardware, or by a combination of tangibly stored software and hardware (and tangibly stored firmware). Electronic devices implementing these aspects of the invention need not be the entire devices as depicted at FIG. 5 but may be one or more components of same such as the above described tangibly stored software, hardware, firmware and DP, or a system on a chip SOC or an application specific integrated circuit ASIC.

In general, the various embodiments of the STA 20 can include, but are not limited to digital devices having wireless communication capabilities such as radio devices with sensors operating in a machine-to-machine type environment; or personal portable radio devices such as but not limited to cellular telephones, navigation devices, laptop/palmtop/tablet computers, digital cameras and music devices, and Internet appliances.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the WLAN and IEEE 802.11ah system, as noted above the exemplary embodiments of this invention may be used with various other types of wireless communication systems such as for example cognitive radio systems or cellular systems as presently in use or as adapted over time in the future to handle machine to machine type communications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

A method comprising:

compiling a traffic indication message which indicates downlink traffic is waiting for a plurality of users; and

only for each nth ones of the users for which a response to the traffic indication message is received, said response identifying the nth user in a time period corresponding to a portion of the traffic indication message which indicates downlink traffic is waiting for that user, scheduling the downlink traffic that is waiting for each of the nth users in each nth slot corresponding to the time period.

The above method, in which the response is an awake indication comprising a sequence, and the traffic indication message is a traffic indication map TIM.
The above method, in which the sequence is a Zadoff Chu sequence.
The above method, in which the method is executed by an access point which sends the traffic indication message in a beacon, and which further sends a block ACK of all of the received responses to the traffic indication message prior to sending the downlink traffic that is waiting for each of the nth users.
The above method, in which the responses to the traffic indication message are received in an awake indication interval and the block ACK further indicates a start of delivery of the scheduled downlink traffic.
The above method, in which:

the responses to the traffic indication message are received in an awake indication interval comprising transmission slots which map, in order, to each separate downlink traffic indication in the traffic indication message; and

scheduling the downlink traffic is in a data delivery interval following the awake indication interval.

A method comprising:

determining that a received traffic indication message indicates downlink traffic is waiting for a particular user;

mapping a portion of the traffic indication message that indicates the downlink traffic is waiting for the particular user to an uplink time period; and

sending in the mapped uplink time period a response indicating that the particular user is awake.

The above method, in which the response is an awake indication comprising a sequence, and the traffic indication message is a traffic indication map TIM.
The above method, in which the sequence is a Zadoff Chu sequence.
The above method, in which the method is executed by the particular user which receives the traffic indication message in a beacon from an access point, and which further receives from the access point prior to receiving the downlink traffic a block ACK of N responses indicating that each nth one of N users is awake.
The above method, in which the N responses and the block ACK are in an awake indication interval and the block ACK further indicates a start of delivery of the downlink traffic.
A method comprising:

mapping a position of a downlink traffic indicator bit in a TIM to an uplink transmission slot, in which the position is associated with a particular STA; and

determining that the STA is ready to receive downlink traffic if a sequence is received in the uplink transmission slot.

A method comprising:

mapping a position of a downlink traffic indicator bit in a TIM to an uplink transmission slot, in which the position is associated with a particular STA; and

indicating that the STA is ready to receive downlink traffic by sending a sequence in the uplink transmission slot.

1-19. (canceled)

20. A method comprising:
compiling a traffic indication message which indicates that downlink traffic is waiting for a plurality of stations, wherein the traffic indication message comprises separate downlink traffic indications for each of the plurality of stations;
mapping a position of a downlink traffic indication in the traffic indication message to an uplink transmission slot, the downlink traffic indication of which is associated with a particular station;
determining that the particular station is ready to receive downlink traffic if a response is received in the uplink transmission slot;
receiving responses from a subset of the plurality of stations, wherein each of the responses is received in a separate uplink transmission slot; and
scheduling the downlink traffic only for the subset of the plurality of stations.

21. The method as in claim 20, in which the response is an awake indication comprising a sequence, and the traffic indication message comprises a traffic indication map (TIM).

22. The method as in claim 21, in which the sequence is a Zadoff Chu sequence.

23. The method as in claim 20, in which the method is executed by an access point which sends the traffic indication message in a beacon.

24. The method as in claim 20, in which the responses to the traffic indication message are received in an awake indication interval and a block acknowledgement further indicates a start of delivery of the scheduled downlink traffic.

25. The method as in claim 20, in which:
the responses to the traffic indication message is received in an awake indication interval comprising transmission slots which map, in order, to each separate downlink traffic indication in the traffic indication message; and
scheduling the downlink traffic is in a data delivery interval following the awake indication interval.

26. A non-transitory program storage device readable by a machine, tangibly embodying a program of instructions executable by the machine for performing operations, the operations comprising the method as claimed in claim 20.

27. An apparatus comprising:
at least one processor; and
at least one non-transitory memory connected to the at least one processor, where the at least one memory comprises at least one computer program;
where the apparatus, including the at least one processor, the at least one memory and the at least one computer program, is configured to:
compile a traffic indication message which indicates that downlink traffic is waiting for a plurality of stations, wherein the traffic indication message comprises separate downlink traffic indications for each of the plurality of stations;
map a position of a downlink traffic indication in the traffic indication message to an uplink transmission slot, the position of which is associated with a particular station;
determine that the particular station is ready to receive downlink traffic if a response is received in the uplink transmission slot;
receive responses from a subset of the plurality of stations, wherein each of the responses is received in a separate uplink transmission slot; and
schedule the downlink traffic only for the subset of the plurality of stations.

28. The apparatus as in claim 27, in which the response is an awake indication comprising a sequence, and the traffic indication message comprises a traffic indication map (TIM).

29. The apparatus as in claim 28, in which the sequence is a Zadoff Chu sequence.

30. The apparatus as in claim 27, in which the method is executed by an access point which sends the traffic indication message in a beacon.

31. The apparatus as in claim 27, in which the responses to the traffic indication message are received in an awake indication interval and a block acknowledgement further indicates a start of delivery of the scheduled downlink traffic.

32. A method comprising:
determining that a received traffic indication message indicates that downlink traffic is waiting for a particular station;
mapping a position of a downlink traffic indication in the traffic indication message to an uplink transmission slot, the downlink traffic indication of which is associated with the particular station; and
sending, in the uplink transmission slot, a response indicating that the particular user is awake.

33. The method as in claim 32, in which the response is an awake indication comprising a sequence, and the traffic indication message is a traffic indication map (TIM).

34. The method as in claim 33, in which the sequence is a Zadoff Chu sequence.

35. The method as in claim 32, in which the method is executed by the particular user which receives the traffic indication message in a beacon from an access point.

36. A non-transitory program storage device readable by a machine, tangibly embodying a program of instructions executable by the machine for performing operations, the operations comprising the method as claimed in claim 32.

37. An apparatus comprising:
at least one processor,
at least one non-transitory memory connected to the at least one processor, where the at least one memory comprises at least one computer program;
where the apparatus, including the at least one processor, the at least one memory and the at least one computer program, is configured to:
determine that a received traffic indication message indicates that downlink traffic is waiting for a particular station;
map a position of a downlink traffic indication in the traffic indication message to an uplink transmission slot, the downlink traffic indication of which is associated with the particular station; and
send, in the uplink transmission slot, a response indicating that the particular user is awake.

38. The apparatus as in claim 37, in which the response is an awake indication comprising a sequence, and the traffic indication message is a traffic indication map (TIM).

39. The apparatus as in claim 38, in which the sequence is a Zadoff Chu sequence.

40. The apparatus as in claim 37, wherein the traffic indication message is received in a beacon from an access point.
